(19) United States
(12) Patent Application Publication
(10) Pub. No.: US 2024/0151223 A1
(43) Pub. Date: May 9, 2024

(54) SELF-MAINTAINING SEALS, PUMPS INCLUDING THE SAME, AND RELATED METHODS

(71) Applicant: CHECKPOINT GROUP, INC., Mandeville, LA (US)

(72) Inventors: Bill Schneck, Madisonville, LA (US); Jack Ray Ferrill, JR., Picayune, MS (US); Adam Canik, Bush, LA (US); Scott Fairley, Mandeville, LA (US); Andrew Elliott, Mandeville, LA (US)

(21) Appl. No.: 18/486,494

(22) Filed: Oct. 13, 2023

Related U.S. Application Data
(60) Provisional application No. 63/415,847, filed on Oct. 13, 2022.
(60) Provisional application No. 63/421,015, filed on Oct. 31, 2022.

(51) Int. Cl. F04B 53/02; F04B 39/10

(52) U.S. Cl. CPC F04B 53/02; F04B 39/10

(57) ABSTRACT

This disclosure includes packing stacks for pumps, pumps having the same, and related methods. Some packing stacks include male and female adapter rings and one or more V-rings, each including a concave surface and an opposing convex surface and configured to be disposed between the male and female adapter rings with the concave surface facing the former and the convex surface facing the latter. In some packing stacks, the male adapter ring includes a body and a ridge projecting from the body, the ridge configured to overlie a central area of the concave surface of the V-ring that is closest to the male adapter ring and less than 40% of the concave surface. In some packing stacks, the male adapter ring has a non-cylindrical interior passageway configured to facilitate fluid flow past the male adapter ring when a plunger is disposed therethrough.

### CROSS REFERENCE TO RELATED APPLICATIONS

The present application claims the benefit of priority to U.S. Provisional Patent Application No. 63/415,847, filed Oct. 13, 2022, and U.S. Provisional Patent Application No. 63/421,015, filed Oct. 31, 2022, which are each incorporated herein by reference in their entirety.

### BACKGROUND

### A. Field of the Invention

The present invention relates generally to pumps, and more specifically, to seals for plunger pumps that are self-maintaining.

### B. Description of Related Art

Typical plunger pumps include a plunger that reciprocates within a discharge chamber between a discharge stroke to pressurize and expel fluid from the discharge chamber and a suction stroke to draw fluid into the discharge chamber. Such pumps also have a seal engaged with the plunger that prevents fluid from exiting the discharge chamber during the discharge stroke, given that the same would at a minimum reduce the fluid pressure providable by the pump, as well as from entering the discharge chamber during the suction stroke, given that air or other fluids might otherwise be drawn into the discharge chamber (e.g., raising the risk of pump-destroying cavitation). By design, this type of seal does not allow fluid to flow through it in either direction.

Such a seal, however, presents a risk of premature failure. For example, without fluid flowing through it, the seal may lack both adequate lubrication and cooling as well as be susceptible to fouling. To illustrate, as the seal wears (e.g., due to poor lubrication and cooling), particles released from the seal can become trapped in the seal or, worse, at the seal-plunger interface, significantly increasing the seal's rate of wear. And in addition to trapping particles, the seal may trap pressure between its components, which can unduly stress the seal and exacerbate its wear.

### SUMMARY OF THE INVENTION

Some of the present pumps can alleviate these issues by including a seal that permits fluid flow through the seal during the pump's suction stroke while preventing fluid flow past the seal during the pump's discharge stroke. To illustrate, some of the present seals comprise packing stacks having a male adapter ring, a female adapter ring, and one or more V-rings, each disposed between the male adapter ring and the female adapter ring with its concave surface facing the male adapter ring, where the male adapter ring is configured to encourage fluid flow through the packing stack. As one example, the male adapter ring can have a body and a ridge projecting therefrom that overlies—and, in some instances, contacts—a central area of the concave surface of the V-ring closest to the male adapter ring and less than 40% of the surface area of the concave surface. In this way, for example, that V-ring—and, optionally, one or more of any V-rings disposed between it and the female adapter ring—may be free to deflect away from the pump's plunger and/or housing during its suction stroke, thus permitting fluid to flow between the packing stack's components (e.g., between the male adapter ring and the V-ring closest to it and, optionally, between adjacent ones of the V-rings and/or between the female adapter ring and the V-ring closest to it) and/or past the packing stack. During the pump's discharge stroke, V-rings that deflected away from the plunger may be forced, by, for example, pressure within the pump's discharge chamber, against the plunger and housing to prevent fluid flow past the packing stack.

As another example, the male adapter ring can have a non-cylindrical interior passageway that permits fluid to flow past the male adapter ring when a plunger is disposed therethrough. Such a non-cylindrical interior passageway, in some packing stacks, may also permit deflection of the V-rings in a manner similar to that described above.

To increase the lubricating, cooling, and cleaning benefits of such through-seal fluid flow, some of the present pumps can be configured such that the discharge chamber is at least partially—up to and including completely—filled during the suction stroke with fluid that flows past the seal from a side of the seal opposite the discharge chamber. In some such pumps, for example, the seal can separate the discharge chamber from a second chamber of the pump, and during the suction stroke, fluid can flow from the second chamber, past the seal, and into the discharge chamber. To illustrate, fluid can flow into the second chamber from an inlet of the pump via one or more passageways of the pump, in some instances, bypassing an inlet check valve of the pump.

Some of the present packing stacks for a pump comprise: a male adapter ring, a female adapter ring, and one or more V-rings, each having a concave surface and a convex surface opposite the concave surface and configured to be disposed between the male adapter ring and the female adapter ring with the concave surface facing the male adapter ring and the convex surface facing the female adapter ring. In some packing stacks, the male adapter ring includes a body and a ridge projecting from the body, the ridge configured to overlie a central area of the concave surface of a first one of the one or more V-rings that is closest to the male adapter ring and less than 40% of the surface area of the concave surface of the first V-ring. In some packing stacks, the male adapter ring has a non-cylindrical interior passageway configured to facilitate fluid flow past the male adapter ring when a plunger is disposed through the interior passageway. In some packing stacks, the interior passageway includes a cylindrical portion extending through the male adapter ring and one or more flow-through portions positioned along the circumference of the cylindrical portion, each extending through the male adapter ring and extending beyond the circumference of the cylindrical portion.

In some packing stacks, the one or more V-rings comprises two or more V-rings. In some packing stacks, the V-ring that is closest to the male adapter ring is more resilient than at least one other of the V-rings. In some packing stacks, the V-ring that is closest to the male adapter ring is elastomeric and the at least one other of the V-rings is non-elastomeric. In some packing stacks, the V-ring that is closest to the male adapter has a yield strength that is at least 1.2 times the yield strength of the at least one other of the V-rings.

In some packing stacks, the female adapter ring has a concave surface corresponding to and configured to underlie the convex surface of a second one of the V-ring(s) that is closest to the female adapter ring, and the concave surface of the female adapter ring has a transverse dimension that is at least 80% of a transverse dimension of the convex surface of the second V-ring.

Some of the present pumps comprise: a housing having a bore, a plunger configured to reciprocate within the bore, an inlet check valve coupled to the housing and configured to permit fluid communication through an inlet of the housing and into the bore during a suction stroke of the plunger, an outlet check valve coupled to the housing and configured to permit fluid communication from the bore and out of an outlet of the housing during a discharge stroke of the plunger, and one of the present packing stacks engaged with the plunger with the male adapter ring positioned closer in fluid communication to the outlet check valve than is the female adapter ring, wherein the packing stack is configured to permit fluid communication through the packing stack during the suction stroke of the plunger and prevent fluid communication past the packing stack during the discharge stroke of the plunger. In some pumps, the packing stack divides the bore into a first chamber and a second chamber, the male adapter ring being positioned closer to the first chamber than is the female adapter ring, and the housing comprises a passage configured to permit fluid communication from the inlet and into the second chamber without flowing through the inlet check valve.

Some of the present methods comprise: retracting a plunger of a pump that is slidably disposed within a bore of the pump, the bore being separated by one of the present packing stacks that is engaged with the plunger into a first chamber and a second chamber with the male adapter ring being positioned closer to the first chamber than is the female adapter ring, wherein the retracting is performed such that fluid flows from the second chamber, past the packing stack, and into the first chamber, and extending the plunger within the bore to push fluid from the first chamber, through an outlet check valve of the pump, and out of an outlet of the pump, during which the packing stack prevents fluid communication from the first chamber and into the second chamber. In some methods, during the retracting, fluid flows from an inlet of the pump, through an inlet check valve of the pump, and into the first chamber. In some methods, during the retracting, fluid flows from an inlet of the pump and into the second chamber. In some methods, during the retracting, fluid flows from an inlet of the pump and into the second chamber without flowing through the inlet check valve.

The term “coupled” is defined as connected, although not necessarily directly, and not necessarily mechanically. Two items that are “coupled” may be unitary with each other or may be connected to one another via one or more intermediate components or elements.

The terms “a” and “an” are defined as one or more unless this disclosure explicitly requires otherwise.

The term “substantially” is defined as largely, but not necessarily wholly, what is specified (and includes what is specified; e.g., substantially 90 degrees includes 90 degrees, and substantially parallel includes parallel), as understood by a person of ordinary skill in the art. In any disclosed embodiment, the terms “substantially,” “approximately,” and “about” may be substituted with “within [a percentage] of” what is specified, where the percentage is 1, 1, 5, or 10%.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and containing”) are open-ended linking verbs. As a result, an apparatus that “comprises,” “has,” “includes,” or “contains” one or more elements possesses those one or more elements, but is not limited to possessing only those one or more elements. Likewise, a method that “comprises,” “has,” “includes,” or “contains” one or more steps possesses those one or more steps, but is not limited to possessing only those one or more steps.

Any embodiment of any of the apparatuses and methods can consist of or consist essentially of—rather than comprise/have/include/contain—any of the described elements, features, and/or steps. Thus, in any of the claims, the phrase “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate identical structures. Rather, the same reference numbers may be used to indicate similar features or features with similar functionalities, as may non-identical reference numbers. The figures are drawn to scale unless otherwise noted, meaning the sizes of the depicted elements in each are accurate relative to each other for at least the embodiment shown.

FIG. 1A is a perspective view of one of the present pumps.

FIGS. 1B-1E are front, back, top, and bottom views, respectively, of the pump of FIG. 1A.

FIG. 2A is a cross-sectional side view of the pump of FIG. 1A, taken along line 2A-2A of FIG. 1C, showing the pump's plunger and seal engaged with the plunger, where the seal permits fluid flow through the seal during the pump's suction stroke and prevents fluid flow past the seal during the pump's discharge stroke.

FIG. 2B is a cross-sectional side view of the pump of FIG. 1A, taken along line 2B-2B of FIG. 1C.

FIG. 2C is a cross-sectional side view of the pump of FIG. 1A, taken along line 2C-2C of FIG. 1C.

FIG. 3A is a cross-sectional side view of the pump of FIG. 1A, taken along line 2A-2A of FIG. 1C, during the pump's suction stroke and illustrating a first path along which fluid can enter the pump's discharge chamber during the suction stroke.

FIG. 3B is a cross-sectional side view of the pump of FIG. 1A, taken along line 2B-2B of FIG. 1C, during the pump's suction stroke and illustrating a second path along which fluid can enter the pump's discharge chamber during the suction stroke, in addition to or alternatively to the first path.

FIG. 3C is a cross-sectional side view of the pump of FIG. 1A, taken along line 2A-2A of FIG. 1C, during the pump's discharge stroke and illustrating a path along which fluid can exit the pump's discharge chamber during the discharge stroke.

FIG. 4A is a cross-sectional side view of the seal—in this instance, a packing stack— of FIG. 1A's pump, taken in a plane that bisects the packing stack, showing the seal's male adapter ring, female adapter ring, and V-rings disposed between the male adapter ring and the female adapter ring.

FIGS. 5A and 5B are front and back views, respectively, of the male adapter ring of FIG. 4A's packing stack.

FIG. 6A is a cross-sectional side view of another of the present seals, taken in a plane that bisects the seal, which is suitable for use in some of the present pumps.

FIG. 6B is a front view of FIG. 6A's seal.

### DETAILED DESCRIPTION

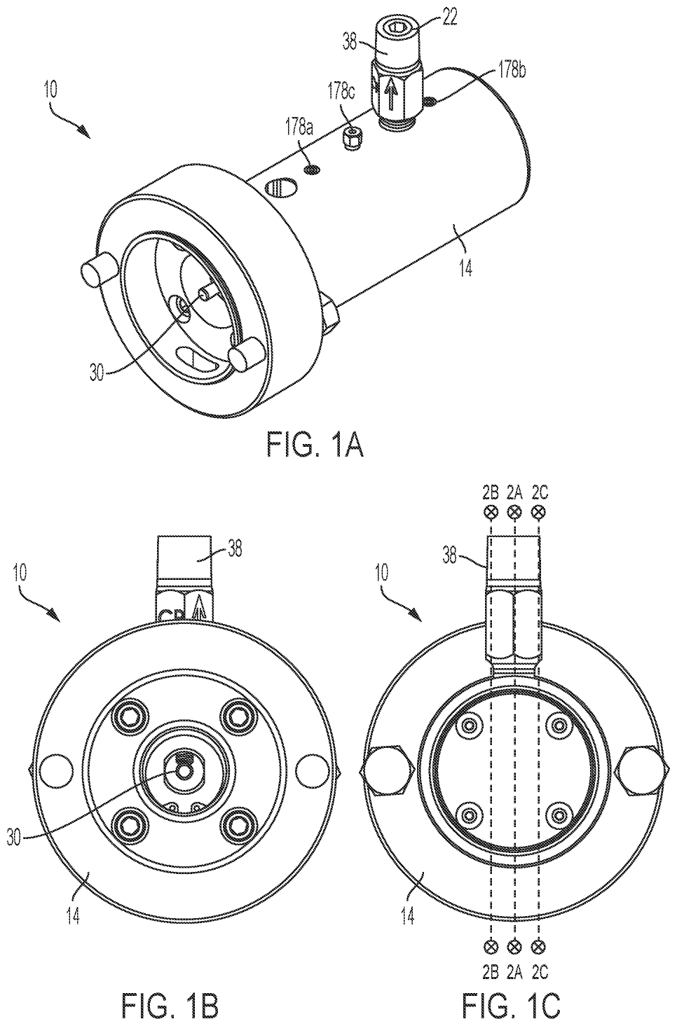

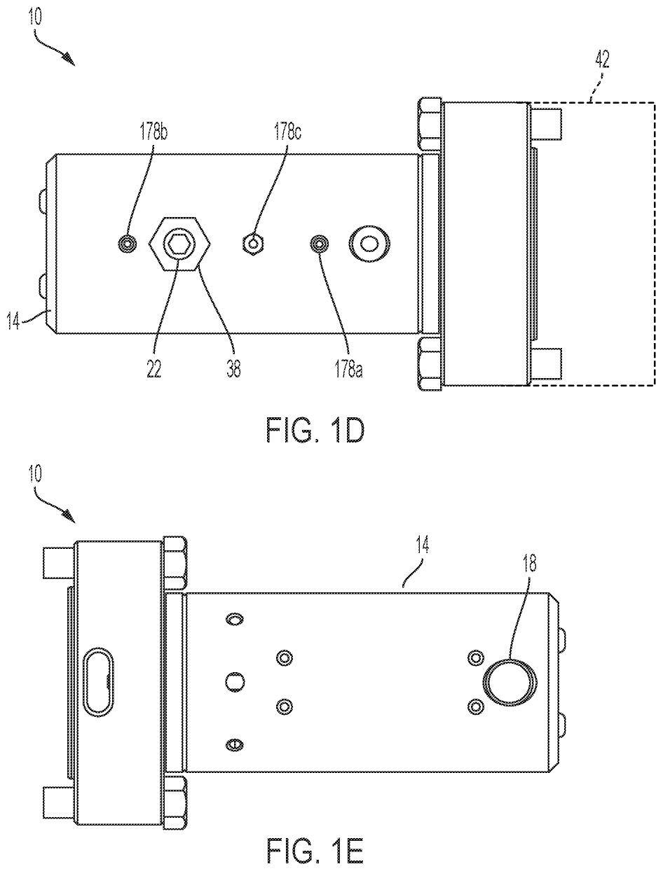

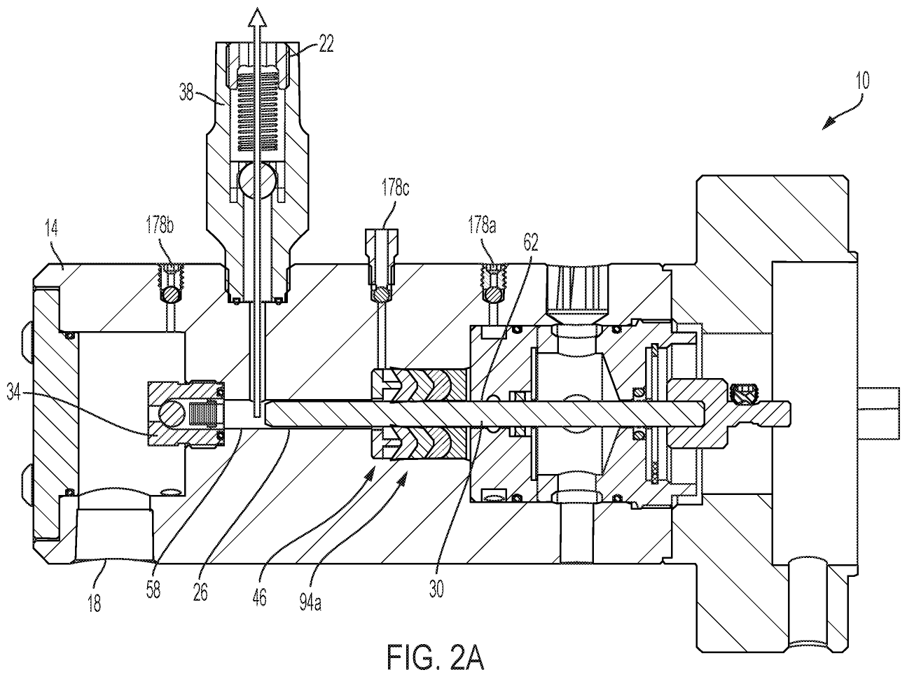

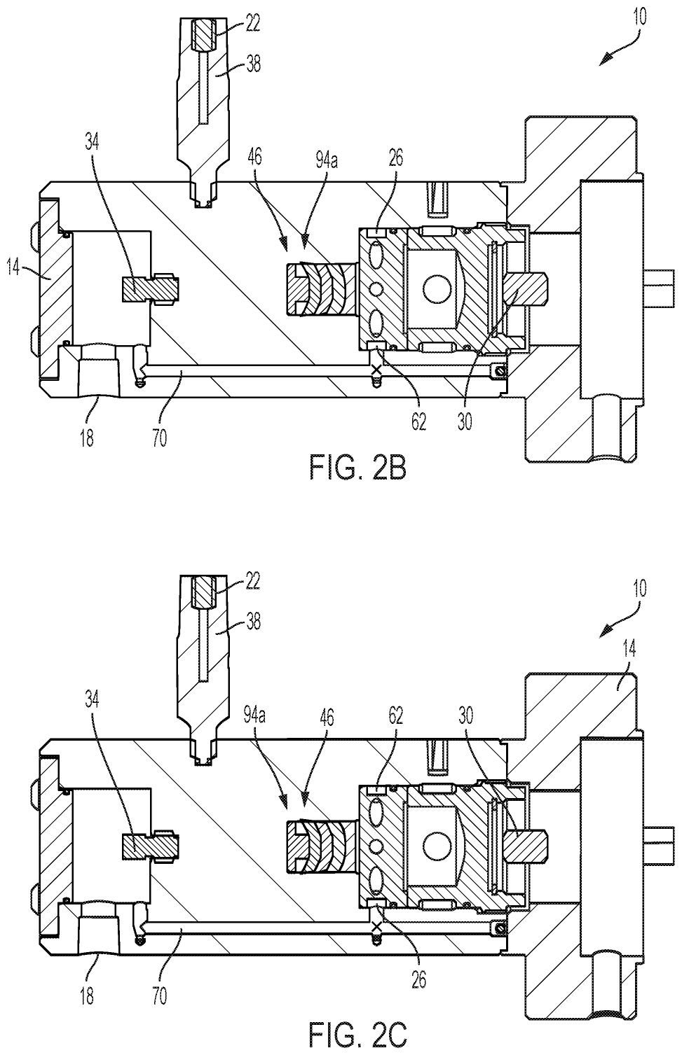

Referring now to the drawings, FIGS. 1A-2A depict one of the present pumps 10. Pump 10 includes a (e.g., one or multi-piece) housing 14 having an inlet 18 and an outlet 22. And as a pump, pump 10 includes a bore 26 and a plunger 30 configured to reciprocate within the bore between a suction stroke to draw fluid into the bore through inlet 18 and a discharge stroke to expel the fluid from the bore through outlet 22. To facilitate such operation, pump 10 can include an inlet check valve 34 that permits fluid flow therethrough into bore 26 from inlet 18 and an outlet check valve 38 that permits fluid flow therethrough out of the bore to outlet 22. Plunger 30 can be driven between the suction and discharge strokes in any suitable fashion, such as, for example, via an electrical, pneumatic, or gas-powered motor or engine 42. Provided by way of illustration, pump 10 is a chemical injection pump that is configured to provide one or more chemicals, such as solvents, de-salting agents, corrosion inhibiters, biocides, clarifiers, scale inhibitors, hydrate inhibitors, oxygen scavengers, surfactants, and/or the like, to an oil and gas well or pipeline. But the present pumps have broader applicability, being usable in any suitable application, and particularly in those involving high pressure, abrasives, and/or chemicals that might otherwise unduly damage a pump.

Pump 10 includes a seal 46 engaged with plunger 30 that is configured to prevent fluid communication past the seal during the pump's discharge stroke and to permit fluid communication through the seal during the pump's suction stroke. As used herein, fluid flow “through” a seal includes fluid flow past one or more components of the seal but not the seal itself, such as past male adapter ring 98 and, optionally, one or more of V-rings 106a-106c, but not past female adapter ring 102, each of which is described below. Fluid flow “through” a seal nevertheless also includes fluid flow past the seal itself, including—if the seal is multi-component—each of its components. In this way, fluid drawn in by pump 10 can lubricate and/or cool seal 46 and/or clean the seal of, for example, seal particulates generated during the pump's operation that might otherwise exacerbate the seal's wear, thereby extending the seal's life.

In pump 10, to illustrate, seal 46 is configured to permit fluid communication not just through, but past, the seal during the pump's suction stroke, which may enhance the lubricating, cooling, and cleaning effect of such through-seal fluid flow. To encourage the same, pump 10's seal 46 can divide bore 26 into a first chamber 58 (i.e., pump 10's discharge chamber) and a second chamber 62. And during the suction stroke, fluid can flow from second chamber 62, past seal 46, and into first chamber 58. Consistent with seal 46 being configured to prevent fluid communication through the seal during pump 10's discharge stroke, the seal is configured to prevent fluid flow between first chamber 58 and second chamber 62 during the same.

As shown, bore 26 need not have a constant transverse dimension. To illustrate, bore 26 includes a first portion—first chamber 58—having a first transverse dimension, a second portion—second chamber 62—having a second transverse dimension that is larger than the first transverse dimension, and a third portion disposed between the first and second portions (e.g., in which seal 46 is disposed), where the third portion has a third transverse dimension that is larger than the first transverse dimension but smaller than the second transverse dimension.

Referring additionally to FIGS. 2B-2C, second chamber 62 can receive fluid during pump 10's suction stroke through one or more passageways 70. Pump 10, to illustrate, includes two such passageways 70; however, others of the present pumps having such passageways can include 1, 2, 3, 4, 5, or more of the passageways. As shown, passageways 70 can permit fluid to flow from inlet 18, through the passageways, and into second chamber 62. More specifically, such fluid flow can bypass inlet check valve 34 via, for example, the entrances to passageways 70 being not-downstream therefrom. In this way, fluid can be encouraged, through lower flow-resistance, to enter second chamber 62—and subsequently first chamber 58 through seal 46—further enhancing the lubricating, cooling, and cleaning effect of such fluid. Pump 10's passageways 70 are internal to housing 14, but in others of the present pumps, such passageways can be at least in part external to the pump's housing.

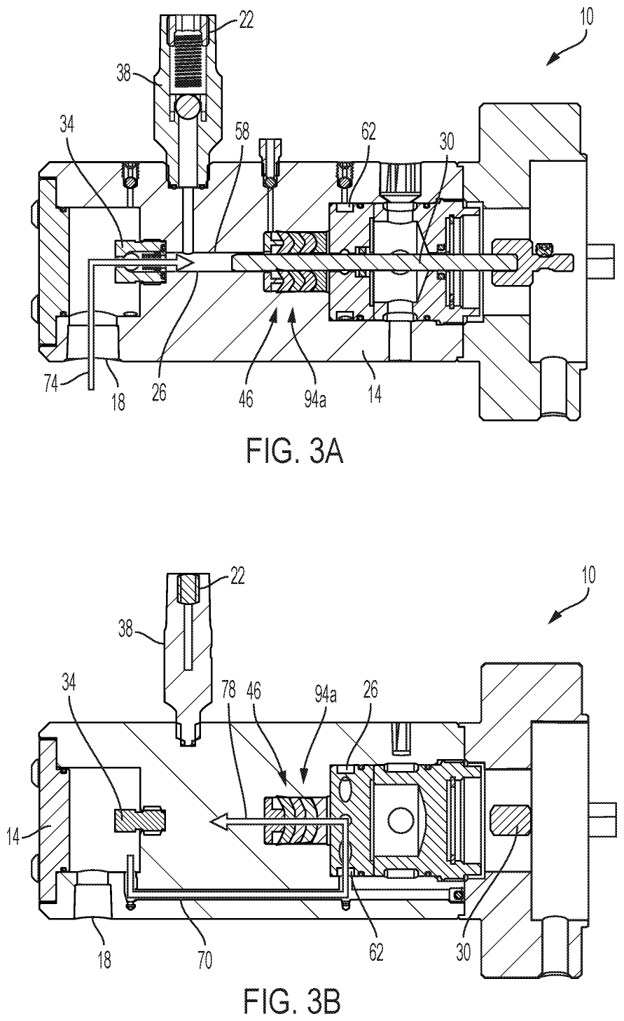

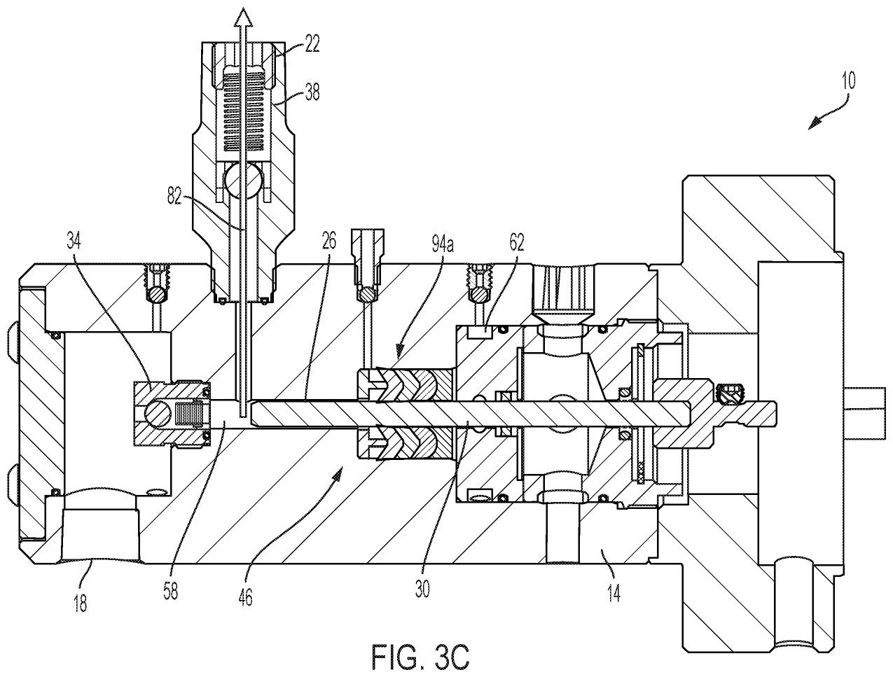

Thus, in pump 10 and referring additionally to FIGS. 3A and 3B, fluid can enter the discharge chamber during the suction stroke from inlet 18 through inlet check valve 34, such as along path 74 (FIG. 3A), as well as through passageways 70, second chamber 62, and seal 46, such as along path 78 (FIG. 3B). Fluid entering the discharge chamber along path 78 can flow through the seal at the seal-plunger interface and/or at the seal-bore interface. The amount of fluid entering pump 10's discharge chamber along path 74 versus along path 78 can be adjusted by, for example, varying inlet check valve 34's cracking pressure. In some pumps, substantially all fluid entering the pump's discharge chamber during the pump's suction stroke can be supplied along a path (e.g., 78) through its seal (e.g., 46), and in some such pumps, an inlet check valve (e.g., 34) can be omitted.

Referring additionally to FIG. 3C, during pump 10's discharge stroke, fluid in the discharge chamber can be expelled therefrom through outlet check valve 38 and outlet 22 (e.g., along path 82). As shown, outlet 22 is defined by outlet check valve 38, but such is not required. To illustrate, in others of the present pumps, an outlet (e.g., 22) of a pump can be defined by the pump's housing (e.g., 14), with, for example, an outlet check valve (e.g., 38) of the pump being internal to the housing, similarly to pump 10's inlet check valve 34.

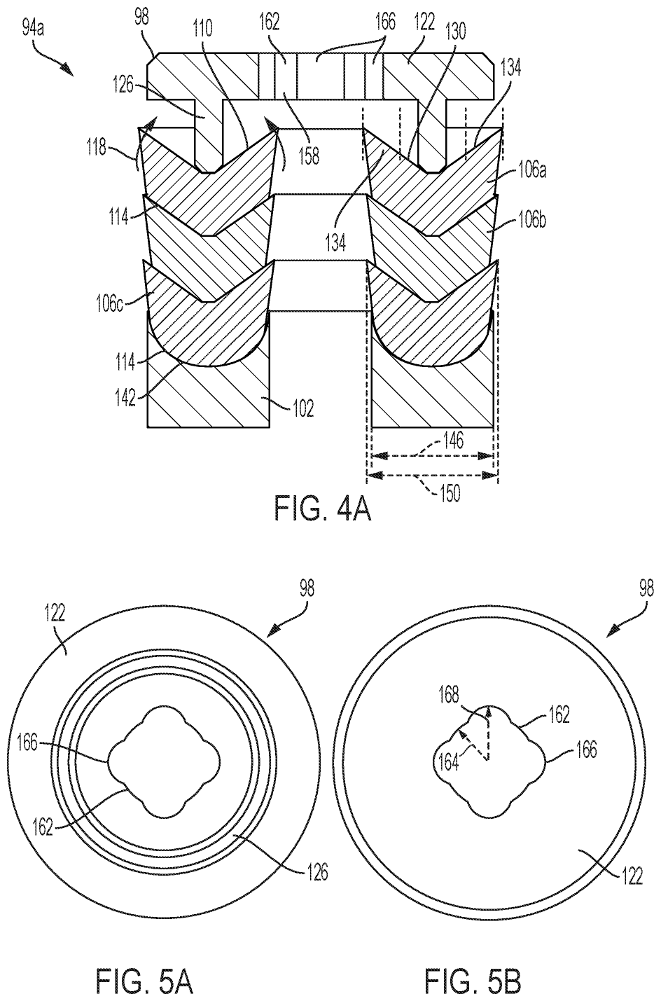

Seal 46 can be any suitable seal that permits the above-described functionality, including, for example, a V-ring seal, a seal incorporating one or more V-rings, a seal incorporating one or more one-way valves, and/or the like. To illustrate and referring additionally to FIG. 4A, pump 10's seal 46 is shown: packing stack 94a. Packing stack 94a includes a male adapter ring 98, a female adapter ring 102, and one or more V-rings 106a-106c disposed between the male adapter ring and the female adapter ring. More particularly, each of V-rings 106a-106c includes a concave surface 110 and a convex surface 114 opposite the concave surface, and the V-ring is disposed between male adapter ring 98 and female adapter ring 102 with the concave surface facing the male adapter ring and the convex surface facing the female adapter ring. And when positioned within a pump (e.g., 10), packing stack 94a is oriented such that male adapter ring 98 is positioned closer in fluid communication to the pump's outlet (e.g., 22) than is female adapter ring 102 and/or, if the pump includes a first chamber (e.g., 58) and a second chamber (e.g., 62), such that the male adapter ring is positioned closer to the first chamber than is the female adapter ring. While packing stack 94a includes 3 V-rings, 106a-106c, others of the present packing stacks can include any suitable number of V-rings, such as, for example, 1, 2, 3, 4, 5, or more V-rings.

The structure of a V-ring (e.g., any of 106a-106c) may result in the V-ring preferentially sealing against fluid flow in a first direction past the V-ring over fluid flow in a second direction past the V-ring that is opposite to the first direction, facilitating a seal (e.g., 46) incorporating the V-ring in achieving the above-described permission of fluid flow therethrough during the suction stroke yet prevention of fluid flow therepast during the discharge stroke. To illustrate, fluid flow attempting to pass the V-ring from its convex surface (e.g., 114) may urge the V-ring to deflect inwardly, whether, for example, through the pressure differential that drives that fluid and/or its momentum, thereby urging the V-ring to an unsealed condition. Similarly, fluid flow attempting to pass the V-ring from its concave surface (e.g., 110) may urge the V-ring to deflect outwardly and thereby to a sealed condition.

Packing stack 94a can leverage this V-ring behavior. To illustrate, male adapter ring 98 can include a body 122 and a ridge 126 projecting from the body. And ridge 126 can be positioned to overlie—and in some instances, contact—an area (e.g., central area 130) of concave surface 110 of V-ring 106a that is closest to the male adapter ring, where that overlaid area is spaced apart from one or both peripheral areas 134 of the concave surface such that the male adapter ring permits inward deflection of those peripheral area(s) (e.g., in directions 118, FIG. 4A) during the suction stroke and thus fluid flow past the V-ring. Such inward deflection of V-ring 106a may, in turn, facilitate similar inward deflection of V-ring 106b and fluid flow therepast and thus similar inward deflection of V-ring 106c and fluid flow therepast. More specifically, ridge 126 can overlie less than or equal to any one of, or between any two of: 80, 75, 70, 65, 60, 55, 50, 45, 40, 35, 30, 25, 20, 15, 10, or 5% (e.g., less than 40%) of V-ring 106a's concave surface 110. This overlaid area can be measured prior to the V-ring's inward deflection; to illustrate, it does not preclude the ridge from overlying more of the V-ring when the V-ring is inwardly deflected (e.g., to support the V-ring in its deflected state). While male adapter ring 98 uses a continuous ridge 126 to achieve the above functionality, that is not required. In others of the present male adapter rings (e.g., 98), for example, a ridge (e.g., 126) can be discontinuous or ridge 126's functionality can be provided for by one or more protrusions that extend from the male adapter ring's body (e.g., 122).

Female adapter ring 102, on the other hand, can facilitate sealing of V-rings 106a-106c during the discharge stroke. For example, female adapter ring 102 can be configured to support V-ring 106c closest to it in its sealed (e.g., engaged with housing 14 and plunger 30) condition, which in turn, can support V-ring 106b and thus V-ring 106a in their sealed conditions. To illustrate, female adapter ring 102 can include a concave surface 142 corresponding to and configured to underlie and, in some instances (e.g., during the discharge stroke), contact, convex surface 114 of V-ring 106c. In order to facilitate such support, concave surface 142 can have a transverse dimension 146 that is greater than or equal to any one of, or between any two of: 50, 55, 60, 65, 70, 75, 80, 85, 90, or 95 of a transverse dimension 150 of convex surface 114 of V-ring 106c and/or can underlie (e.g., and contact) greater than or equal to any one of, or between any two of: 50, 55, 60, 65, 70, 75, 80, 85, or 90% of the surface area of the convex surface.

Referring additionally to FIGS. 5A and 5B, male adapter ring 98 can encourage fluid flow past it—and thus, through packing stack 94a—in other ways. For example, male adapter ring 98 can include an interior passageway 158 having a cross-sectional area that is larger than (e.g., at least 1.05, 1.10, 1.20, 1.30, 1.40, 1.50, 1.60, or 1.70 times) a cross-sectional area of a portion of a plunger (e.g., 30) or tubular that it is configured to receive, a minimum cross-sectional area of the interior passageway of one or more of V-rings 106a-106c (e.g., when undeflected), and/or the like. In this way, when the plunger is disposed through interior passageway 158 of male adapter ring 98, the interior passageway is nevertheless configured—through its cross-sectional area—to facilitate fluid flow therepast.

To illustrate in pump 10, the portion of plunger 30 received by male adapter ring 98's interior passageway 158 is cylindrical, and correspondingly, the interior passageway can be non-cylindrical. More specifically, interior passageway 158 can include a cylindrical portion 162 that extends through male adapter ring 98 as well as one or more flow-through portions 166 disposed along the circumference of the cylindrical portion, each extending through the male adapter ring and extending beyond the circumference of the cylindrical portion. The radius (e.g., 164) of cylindrical portion 162 can correspond to the radius of the plunger to facilitate proper positioning of the plunger relative to male adapter ring 98 and the rest of packing stack 94a, while larger-radius—measured from the centerline of cylindrical portion 162 (e.g., radius 168)—flow-through portions 166 can encourage fluid flow past the male adapter ring and thus through the packing stack.

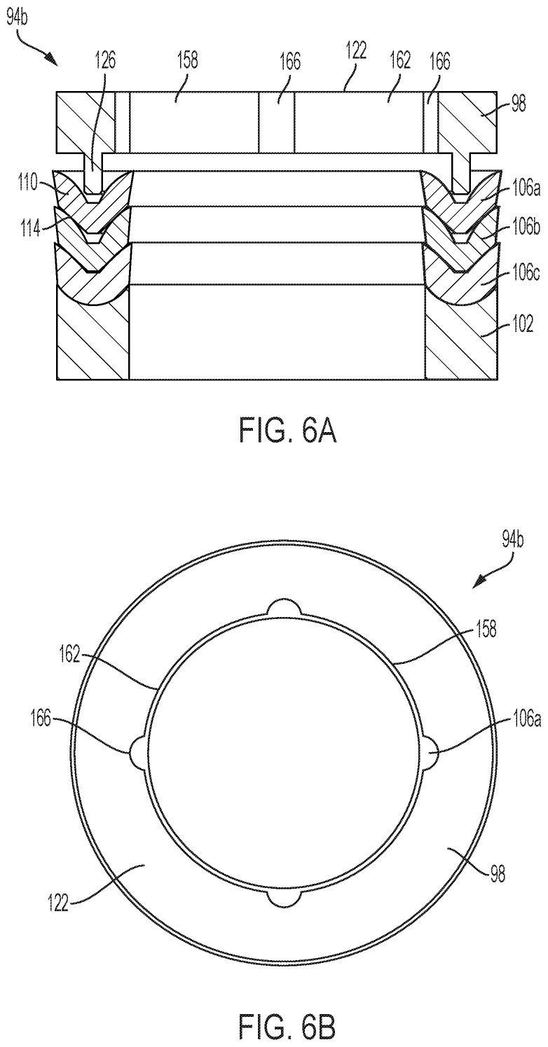

During operation of pump 10, packing stack 94a's components, such as male adapter ring 98, one or more of V-rings 106a-106c, and/or female adapter ring 102 may move relative to other components of the packing stack in an axial direction that is aligned with the direction of plunger 30's movement. Though they depict different embodiments of the present packing stacks, FIGS. 4A and 6A provide an example of such movement. In particular, FIG. 4A shows male adapter ring 98 in contact with V-ring 106a, which may occur during pump 10's discharge stroke as the packing stack is compressed, and FIG. 6A shows male adapter ring 98 moved relative to and out of contact with V-ring 106a, which may occur when such compression is relieved during the pump's suction stroke. This relative movement of a packing stack's (e.g., 94a or 94b) components can occur not just between male adapter ring 98 and V-ring 106a, but also between V-ring 106a and V-ring 106b, V-ring 106b and V-ring 106c, and/or V-ring 106c and female adapter ring 102. And in this way, flow through the packing stack can be enhanced, along with the cooling, cleaning, and lubricating benefits of the same. For example, as a given two of the packing stack's components move away from one another, fluid can be encouraged to flow between those components, and as the two components move toward one another, that fluid can be encouraged to flow out from between those components (e.g., akin to a pumping action). Components comprising a resilient material (e.g., V-ring 106a), as discussed below, may be more apt to exhibit or may facilitate such relative movement.

Packing stack 94a's operation can be enhanced by material selection of V-rings 106a-106c. To illustrate, at least one of V-rings 106a-106c can be resilient, which can facilitate movement of the V-ring from its inwardly-deflected, during-suction-stroke position back to its sealing position (e.g., against housing 14 and plunger 30) as well encourage the same for others of the V-rings, particularly those disposed between the V-ring and female adapter ring 102. While in some pumps, each of the V-ring(s) can be resilient, it may be desirable in other pumps to include particularly chemically-resistant V-ring(s). And given that resilient materials, such as elastomers, may be less chemically-resistant than other, less-resilient materials, such as polytetrafluoroethylene (PTFE), and vice versa, a balance between these materials can be struck. For example, in pump 10, V-ring 106a that is closest to male adapter ring 98 can be more resilient than at least one other—up to and including each—of V-rings 106b and 106c. More specifically, V-ring 106a can have a yield strength that is greater than any one of, or between any two of, 1.1, 1.2, 1.3, 1.4, 1.5, 1.6, 1.7, 1.8, 1.9, or 2.0 times (e.g., 1.2 times) the yield strength of V-rings 106b and/or 106c. To illustrate using pump 10, V-ring 106a can comprise an elastomer, and V-rings 106b and 106c can comprise a chemically-resilient material, such as PTFE (e.g., fiber-reinforced PTFE). Male adapter ring 98 and/or female adapter ring 102 can be made of relatively rigid material, such as, for example, polyether ether ketone (PEEK), or a relatively chemically-resistant material, such as (e.g., fiber-reinforced) PTFE. To illustrate, male adapter ring 98 can be made of a relatively chemically-resistant material (e.g., fiber-reinforced PTFE), and female adapter ring 102 can be made of a relatively rigid material (e.g., PEEK).

Referring now to FIGS. 6A and 6B, shown is another embodiment of the present seals, packing stack 94b. Packing stack 94b is substantially similar to packing stack 94a with the primary exception being that packing stack 94b is for use with a larger diameter plunger 30 than is packing stack 94a. More specifically, packing stack 94b is for use with a 1-inch diameter plunger 30, and packing stack 94a is for use with a 0.25-inch diameter plunger 30. As these two packing stacks illustrate, the present packing stacks can be sized for use with any size plunger, such as, for example, a plunger having a diameter that is greater than or equal to any one of, or between any two of: 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1.00, 1.25, 1.50, 1.75, 2.00, 2.25, 2.50, 2.75, or 3.00 inches.

Referring back to FIGS. 1A-3C, as a pump, pump 10 includes bleeder valves 178a-178c to prevent potentially pump-destroying cavitation. This includes a bleeder valve 178b associated with inlet 18 and a bleeder valve 178a associated with second chamber 62. Given that seal 46 selectively allows fluid to flow through it, however, such bleeder valves also include a bleeder valve 178c that is closer in fluid communication with the seal than it is to first chamber 58 or second chamber 62, which permits bleeding of the seal itself, the portion of bore 26 containing the seal, and the first chamber.

Some of the present methods comprise retracting a plunger (e.g., 30) of a pump (e.g., 10) that is slidably disposed within a bore (e.g., 26) of the pump, the bore being separated by a seal (e.g., 46) that is engaged with the plunger into a first chamber (e.g., 58) and a second chamber (e.g., 62), wherein the retracting is performed such that fluid flows from the second chamber, past the seal, and into the first chamber. During the retracting, fluid can flow from an inlet (e.g., 18) of the pump and into the second chamber, in some instances, without flowing through an inlet check valve (e.g., 34) of the pump (e.g., along path 78). In some methods, during the retracting, fluid can also flow from the inlet, through the inlet check valve, and into the first chamber (e.g., along path 74). The plunger can then be extended to push fluid from the first chamber, through an outlet check valve (e.g., 38) of the pump, and out of an outlet (e.g., 22) of the pump, during which the seal prevents fluid communication from the first chamber and into the second chamber.

In some methods, the seal comprises a packing stack (e.g., 94a or 94b) that includes a male adapter ring (e.g., 98) and a female adapter ring (e.g., 102), the male adapter ring being positioned closer to the first chamber than is the female adapter ring, and one or more V-rings (e.g., 106a-106c) disposed between the male adapter ring and the female adapter ring, each of the one or more V-rings having a concave surface (e.g., 110) facing the male adapter ring and a convex surface (e.g., 114) facing the female adapter ring. In some methods, the male adapter ring comprises a body (e.g., 122) and a ridge (e.g., 126) projecting from the body, the ridge configured to overlie a central area (e.g., 130) of the concave surface of a first one of the V-rings that is closest to the male adapter ring and less than 40% of the surface area of the concave surface of the first V-ring. In some methods, the female adapter ring has a concave surface (e.g., 142) corresponding to and underlying the convex surface (e.g., 114) of a second one of the V-rings that is closest to the female adapter ring, and the concave surface of the female adapter ring has a transverse dimension (e.g., 146) that is at least 80% of a transverse dimension (e.g., 150) of the convex surface of the second V-ring. The first and second V-rings can be the same V-ring.

In some methods, the male adapter ring has a non-cylindrical interior passageway (e.g., 158) configured to facilitate fluid flow past the male adapter ring. In some methods, the interior passageway includes a cylindrical portion (e.g., 162) extending through the male adapter ring and one or more flow-through portions (e.g., 166) positioned along the circumference of the cylindrical portion, each extending through the male adapter ring and extending beyond the circumference of the cylindrical portion.

In some methods, the one or more V-rings comprise two or more V-rings. And in some methods, the V-ring that is closest to the male adapter ring is more resilient than at least one other of the V-rings. In some methods, the V-ring that is closest to the male adapter ring is elastomeric and the at least one other of the V-rings is non-elastomeric. In some methods, the V-ring that is closest to the male adapter ring has a yield strength that is at least 1.2 times the yield strength of the at least one other of the V-rings.

The above specification and examples provide a complete description of the structure and use of illustrative embodiments. Although certain embodiments have been described above with a certain degree of particularity, or with reference to one or more individual embodiments, those of ordinary skill in the art could make numerous alterations to the disclosed embodiments without departing from the scope of this invention. As such, the various illustrative embodiments of the apparatuses and methods are not intended to be limited to the particular forms disclosed. Rather, they include all modifications and alternatives falling within the scope of the claims, and embodiments other than the ones shown may include some or all of the features of the depicted embodiments. For example, elements may be omitted or combined as a unitary structure, and/or connections may be substituted. Further, where appropriate, aspects of any of the examples described above may be combined with aspects of any of the other examples described to form further examples having comparable or different properties and/or functions and addressing the same or different problems. Similarly, it will be understood that the benefits and advantages described above may relate to one embodiment or may relate to several embodiments.

The claims are not intended to include, and should not be interpreted to include, means plus- or step-plus-function limitations, unless such a limitation is explicitly recited in a given claim using the phrase(s) “means for” or “step for,” respectively.

1. A packing stack for a pump, the packing stack comprising:
a male adapter ring;
a female adapter ring; and
one or more V-rings, each:
having a concave surface and a convex surface opposite the concave surface; and
configured to be disposed between the male adapter ring and the female adapter ring with the concave surface facing the male adapter ring and the convex surface facing the female adapter ring;
wherein the male adapter ring includes:
a body; and
a ridge projecting from the body, the ridge configured to overlie:
a central area of the concave surface of a first one of the one or more V-rings that is closest to the male adapter ring; and
less than 40% of the surface area of the concave surface of the first V-ring.

2. The packing stack of claim 1, wherein the male adapter ring has a non-cylindrical interior passageway configured to facilitate fluid flow past the male adapter ring when a plunger is disposed through the interior passageway.

3. A packing stack for a pump, the packing stack comprising:
a male adapter ring;
a female adapter ring; and
one or more V-rings, each:
having a concave surface and a convex surface opposite the concave surface; and
configured to be disposed between the male adapter ring and the female adapter ring with the concave surface facing the male adapter ring and the convex surface facing the female adapter ring;
wherein the male adapter ring has a non-cylindrical interior passageway configured to facilitate fluid flow past the male adapter ring when a plunger is disposed through the interior passageway.

4. The packing stack of claim 3, wherein the interior passageway includes:
a cylindrical portion extending through the male adapter ring; and
one or more flow-through portions positioned along the circumference of the cylindrical portion, each:
extending through the male adapter ring; and
extending beyond the circumference of the cylindrical portion.

5. The packing stack of claim 3, wherein the one or more V-rings comprises two or more V-rings.

6. The packing stack of claim 5, wherein the V-ring that is closest to the male adapter ring is more resilient than at least one other of the V-rings.

7. The packing stack of claim 6, wherein the V-ring that is closest to the male adapter ring is elastomeric and the at least one other of the V-rings is non-elastomeric.

8. The packing stack of claim 6, wherein the V-ring that is closest to the male adapter ring has a yield strength that is at least 1.2 times the yield strength of at least one other of the V-rings.

9. The packing stack of claim 3, wherein:
the female adapter ring has a concave surface corresponding to and configured to underlie the convex surface of a second one of the V-ring(s) that is closest to the female adapter ring; and
the concave surface of the female adapter ring has a transverse dimension that is at least 80% of a transverse dimension of the convex surface of the second V-ring.

10. A pump comprising:
a housing having a bore;
a plunger configured to reciprocate within the bore;
an inlet check valve coupled to the housing and configured to permit fluid communication through an inlet of the housing and into the bore during a suction stroke of the plunger;
an outlet check valve coupled to the housing and configured to permit fluid communication from the bore and out of an outlet of the housing during a discharge stroke of the plunger; and
a packing stack engaged with the plunger, the packing stack having:
a male adapter ring and a female adapter ring, the male adapter ring being positioned closer in fluid communication to the outlet check valve than is the female adapter ring; and
one or more V-rings disposed between the male adapter ring and the female adapter ring, each of the one or more V-rings having a concave surface facing the male adapter ring and a convex surface facing the female adapter ring;
wherein the packing stack is configured to:
permit fluid communication through the packing stack during the suction stroke of the plunger; and
prevent fluid communication past the packing stack during the discharge stroke of the plunger.

11. The pump of claim 10, wherein:
the packing stack divides the bore into a first chamber and a second chamber, the male adapter ring being positioned closer to the first chamber than is the female adapter ring; and
the housing comprises a passage configured to permit fluid communication from the inlet and into the second chamber without flowing through the inlet check valve.

12. The pump of claim 10, wherein the male adapter ring comprises:
a body; and
a ridge projecting from the body, the ridge configured to overlie:
a central area of the concave surface of a first one of the one or more V-rings that is closest to the male adapter ring; and
less than 40% of the surface area of the concave surface of the first V-ring.

13. The pump of claim 10, wherein the male adapter ring has a non-cylindrical interior passageway configured to facilitate fluid flow past the male adapter ring.

14. The pump of claim 13, wherein the interior passageway includes:
a cylindrical portion extending through the male adapter ring; and
one or more flow-through portions positioned along the circumference of the cylindrical portion, each:
extending through the male adapter ring; and
extending beyond the circumference of the cylindrical portion.

15. The pump of claim 10, wherein the one or more V-rings comprises two or more V-rings.

16. The pump of claim 15, wherein the V-ring that is closest to the male adapter ring is more resilient than at least one other of the V-rings.

17. The pump of claim 16, wherein the V-ring that is closest to the male adapter ring is elastomeric and the at least one other of the V-rings is non-elastomeric.

18. The pump of claim 16, wherein the V-ring that is closest to the male adapter ring has a yield strength that is at least 1.2 times the yield strength of the at least one other of the V-rings.

19. The pump of claim 10, wherein:
the female adapter ring has a concave surface corresponding to and underlying the convex surface of a second one of the V-ring(s) that is closest to the female adapter ring; and
the concave surface of the female adapter ring has a transverse dimension that is at least 80% of a transverse dimension of the convex surface of the second V-ring.

20. A method comprising:
retracting a plunger of a pump that is slidably disposed within a bore of the pump, the bore being separated by a packing stack that is engaged with the plunger into a first chamber and a second chamber, wherein:
the packing stack includes:
a male adapter ring and a female adapter ring, the male adapter ring being positioned closer to the first chamber than is the female adapter ring; and
one or more V-rings disposed between the male adapter ring and the female adapter ring, each of the one or more V-rings having a concave surface facing the male adapter ring and a convex surface facing the female adapter ring; and
the retracting is performed such that fluid flows from the second chamber, past the packing stack, and into the first chamber; and
extending the plunger within the bore to push fluid from the first chamber, through an outlet check valve of the pump, and out of an outlet of the pump, during which the packing stack prevents fluid communication from the first chamber and into the second chamber.

21. The method of claim 20, wherein, during the retracting, fluid flows from an inlet of the pump, through an inlet check valve of the pump, and into the first chamber.

22. The method of claim 21, wherein, during the retracting, fluid flows from an inlet of the pump and into the second chamber without flowing through the inlet check valve.

23. The method of claim 20, wherein, during the retracting, fluid flows from an inlet of the pump and into the second chamber.

24. The method of claim 20, wherein the male adapter ring comprises:
a body; and
a ridge projecting from the body, the ridge configured to overlie:
a central area of the concave surface of a first one of the one or more V-rings that is closest to the male adapter ring; and
less than 40% of the surface area of the concave surface of the first V-ring.

25. The method of claim 20, wherein the male adapter ring has a non-cylindrical interior passageway configured to facilitate fluid flow past the male adapter ring.

26. The method of claim 25, wherein the interior passageway includes:
a cylindrical portion extending through the male adapter ring; and
one or more flow-through portions positioned along the circumference of the cylindrical portion, each:
extending through the male adapter ring; and
extending beyond the circumference of the cylindrical portion.

27. The method of claim 20, wherein the one or more V-rings comprises two or more V-rings.

28. The method of claim 27, wherein the V-ring that is closest to the male adapter ring is more resilient than at least one other of the V-rings.

29. The method of claim 28, wherein the V-ring that is closest to the male adapter ring is elastomeric and the at least one other of the V-rings is non-elastomeric.

30. The method of claim 28, wherein the V-ring that is closest to the male adapter ring has a yield strength that is at least 1.2 times the yield strength of the at least one other of the V-rings.

31. The method of claim 20, wherein:
the female adapter ring has a concave surface corresponding to and underlying the convex surface of a second one of the V-ring(s) that is closest to the female adapter ring; and
the concave surface of the female adapter ring has a transverse dimension that is at least 80% of a transverse dimension of the convex surface of the second V-ring.
